(19) United States
(12) Patent Application Publication
(10) Pub. No.: US 2010/0240846 A1
(43) Pub. Date: Sep. 23, 2010

(54) Catalyst component for the polymerization of olefins based on 1,3-diethers

(75) Inventors: Gianni Collina, Ferrara (IT); Ofelia Fusco, Ferrara (IT); Benedetta Gaddi, Ferrara (IT); Giampiero Morini, Padova (IT); Mario Sacchetti, Ferrara (IT); Gianni Vitale, Ferrara (IT)

Correspondence Address: BASELL USA INC., NEWTOWN SQUARE CENTER, 3801 WEST CHESTER PIKE, BLDG. B, NEWTOWN SQUARE, PA, 19073, US

(73) Assignee: BASEL POLIOLEFINE ITALIA S.R.L., Milan (IT)

(21) Appl. No.: 12/308,423

(22) PCT Filed: Jun. 1, 2007
(86) PCT No.: PCT/EP2007/055392

§ 371 Date: Dec. 15, 2008

Related U.S. Application Data
(60) Provisional application No. 60/817,544, filed on Jun. 29, 2006.

(30) Foreign Application Priority Data
Jun. 22, 2006 (EP) 06115883.8

(51) Int. Cl. C08F 4/602; C08F 4/60

(52) U.S. Cl. 526/123.1; 502/126; 502/115; 502/116

(57) ABSTRACT

Catalyst components for the polymerization of olefins comprising Mg, Ti, halogen and 1,3-diethers as internal donors having an improved balance of properties in terms of activity and morphological stability are obtained by a process comprising: (A) A first step comprising reacting an adduct of formula MgCl₂(ROH)ₙ, where R is a C1-C10 alkyl group, and n is from 0.5 to 6, with a titanium compound having at least a Ti—Cl bond at a reaction temperature ranging from 0° C. to 80° C.; (B) A subsequent step comprising contacting the solid product obtained in (A) with an electron donor ED selected from 1,3 diethers with a titanium compound having at least a Ti—Cl bond at a temperature higher than 80° C.; and (C) A subsequent step comprising reacting the solid product coming from (B) with a titanium compound having at least a Ti—Cl bond at a temperature higher than 80° C.

The present invention relates to a process for the preparation of a catalyst component for the polymerization of olefins comprising magnesium, titanium and an electron donor selected from the group of 1,3-diethers.

It is known in the art that high yield catalytic components of Ziegler-Natta type can be obtained by contacting a titanium compound comprising at least a titanium-halogen bond with a solid support comprising a magnesium halide. Solid catalytic components of the Ziegler-Natta type are obtained, for instance, by reacting TiCl₄ with a support containing a magnesium compound that can be a magnesium dihalide, such as MgCl₂, or an alcoholate or haloalcoholates of magnesium, such as ethoxymagnesiumchloride or diethoxymagnesium. A particular type of support consists of adducts of MgCl₂ with aliphatic alcohols, such as ethanol, in the form of spherical particles. It is known that in order to obtain a more effective catalyst component, the titanation of the particles of the solid support should be carried out at a high temperature, generally above 80° C., and preferably in the range 90-130° C.

When a supported catalyst is produced for the polymerisation of propylene or higher α-olefins, it is necessary the presence of an internal electron donor compound in the solid catalytic component. In fact, the presence of said electron-donating compound (Di) allows the preparation of supported catalysts endowed not only with a high catalytic activity, but also with a high stereospecifity.

Electron donor compounds suitable for the preparation of solid catalyst components can be selected from esters, ketones, amides and amines. A particular class of suitable internal electron donors is represented by mono- and di-alkyl esters of aromatic carboxylic acids, such as diisobutylphtalate or ethylbenzoate. Besides these compounds, also specific ethers have been proved to be effective as internal donors.

EP 361 494 discloses solid catalyst components comprising, as an internal electron-donor, an ether containing two or more ether groups, preferably in 1,3 position, and having specific reaction characteristics towards the anhydrous magnesium chloride and TiCl₄. In particular, this ether is capable of forming complexes with activated anhydrous magnesium dichloride in a quantity of less than 60 mmoles per 100 g of MgCl₂ and it enters into substitution reactions with TiClₐ for less than 50% by moles. The presence of the above 1,3-diethers in the solid catalytic component causes a remarkable increase of the catalytic activity of the final catalyst, with respect to the case of a conventional electron donor selected from phthalates or ethylbenzoate. Moreover, the catalysts obtained from the reaction of said catalyst component with an Al-alkyl compound exhibit high stereospecifity in the polymerization of olefins, even in the absence of an external electron donor (De). In fact, according to EP 361 494 the use of the above diethers allows to achieve good results in term of activity and stereospecifity even without including an external electron donor compound in the catalyst system.

Another advantage correlated to the presence of a 1,3-diether in the solid catalyst component consists in providing an improved control of the final molecular weight of the obtained polymer, which makes possible also the production of polymers with very high melt flow rates, as those disclosed in EP 622380. In other words, the presence of a 1,3-diether in the solid catalytic component makes more effective the amount of hydrogen introduced during the polymerization in the regulation of the length of polymeric chains. As a consequence, the use of a 1,3-diether as an electron donor not only makes more flexible the polymerization process itself, but also allows to widen the range of products having different average molecular weight.

EP 728 769 refers to electron donors selected from 1,3-diethers, in which the carbon atom in position 2 belongs to a specific cyclic structure containing at least two unsaturations (cyclopolyenic structure). Said cyclopolyenic 1,3-diethers confer a further increase of the catalyst activity with respect to the ethers heretofore known. Furthermore, the cyclopolyenic 1,3-diethers can be successfully used both as internal and external electron donor compounds.

According to EP 728 769 a solid catalyst component is obtained by reacting a MgCl₂.nROH adduct in the form of spheroidal particles, where n is 1-3 and ROH is preferably ethanol, with an excess of TiCl₄ containing a cyclopolyenic 1,3-diether as electron donor. The temperature of the initial contact is in the range from 0 to 25° C., but then is increased to reach a reaction temperature in the range of 80-135° C. in order to ensure an effective titanation. After a time ranging from 30 minutes to 2 hours, the reaction product comprising the titanated solid support is separated from the liquid phase. After the separation of the liquid phase, one or more further steps of titanation can be carried out under conditions similar to those described above. After the last reaction with TiCl₄, the obtained solid is separated, for example by way of filtration, and washed with a hydrocarbon solvent until no chlorine ions can be detected in the washing liquid. Notwithstanding the good polymerization activity the balance of properties should still be improved particularly in terms of morphological stability (expressed by polymer bulk density and percentage of breakage).

The applicant has now found that a catalyst component for the polymerization of olefins comprising Mg, Ti, halogen and 1,3-diethers as internal donors having an improved balance of properties in terms of activity and morphological stability is obtained by a process comprising:
(A) A first step comprising reacting an adduct of formula MgCl₂(ROH)ₙ, where R is a C1-C10 alkyl group, and n is from 0.5 to 6, with a titanium compound having at least a Ti—Cl bond at a reaction temperature ranging from 0° C. to 80° C.;
(B) A subsequent step comprising contacting the solid product obtained in (A) with an electron donor ED selected from 1,3 diethers with a titanium compound having at least a Ti—Cl bond at a temperature higher than 80° C.; and
(C) A subsequent step comprising reacting the solid product coming from (B) with a titanium compound having at least a Ti—Cl bond at a temperature higher than 80° C.

The so obtained catalyst component is able to offer good balance of catalyst performances in terms of activity/stereospecificity and particularly morphological properties.

The 1,3-diether used in step (B) is preferably selected from those of formula

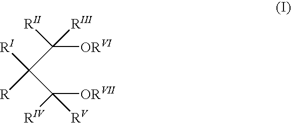

wherein R, R^{I}, R^{II}, R^{III}, R^{IV} and R^{V} equal or different to each other, are hydrogen or hydrocarbon radicals having from 1 to 18 carbon atoms, and R^{VI} and R^{VII}, equal or different from each other, have the same meaning of R-R^{V} except that they cannot be hydrogen; one or more of the R-R^{VII} groups can be linked to form a cycle. The 1,3-diethers in which R^{VI} and R^{VII} are selected from C₁-C₄ alkyl radicals are particularly preferred.

Furthermore, particularly preferred are the 1,3-diethers of formula (II)

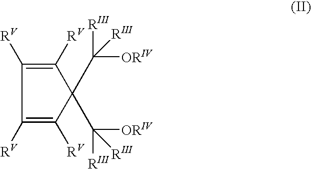

where the radicals R^{IV} have the same meaning explained above and the radicals R^{III} and R^{V} radicals, equal or different to each other, are selected from the group consisting of hydrogen; halogens, preferably Cl and F; C₁-C₂₀ alkyl radicals, linear or branched; C₃-C₂₀ cycloalkyl, C₆-C₂₀ aryl, C₇-C₂₀ alkaryl and C₇-C₂₀ aralkyl radicals and two or more of the R^{V} radicals can be bonded to each other to form condensed cyclic structures, saturated or unsaturated, optionally substituted with R^{VI} radicals selected from the group consisting of halogens, preferably Cl and F; C₁-C₂₀ alkyl radicals, linear or branched; C₃-C₂₀ cycloalkyl, C₆-C₂₀ aryl, C₇-C₂₀ alkaryl and C₇-C₂₀ aralkyl radicals; said radicals R^{V} and R^{VI} optionally containing one or more heteroatoms as substitutes for carbon or hydrogen atoms, or both.

Preferably, in the 1,3-diethers of formulae (I) and (II) all the R^{III} radicals are hydrogen, and all the R^{IV} radicals are methyl. Moreover, are particularly preferred the 1,3-diethers of formula (II) in which two or more of the R^{V} radicals are bonded to each other to form one or more condensed cyclic structures, preferably benzenic, optionally substituted by R^{VI} radicals. Specially preferred are the compounds of formula (III):

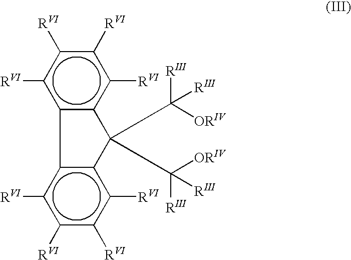

where the R^{VI} radicals equal or different are hydrogen; halogens, preferably Cl and F; C₁-C₂₀ alkyl radicals, linear or branched; C₃-C₂₀ cycloalkyl, C₆-C₂₀ aryl, C₇-C₂₀ alkylaryl and C₇-C₂₀ aralkyl radicals, optionally containing one or more heteroatoms selected from the group consisting of N, O, S, P, Si and halogens, in particular Cl and F, as substitutes for carbon or hydrogen atoms, or both; the radicals R^{III} and R^{IV} are as defined above for formula (II).

Specific examples of compounds comprised in formulae (II) and (III) are:
1,1-bis(methoxymethyl)-cyclopentadiene;
1,1-bis(methoxymethyl)-2,3,4,5-tetramethylcyclopentadiene;
1,1-bis(methoxymethyl)-2,3,4,5-tetraphenylcyclopentadiene;
1,1-bis(methoxymethyl)-2,3,4,5-tetrafluorocyclopentadiene;
1,1-bis(methoxymethyl)-3,4-dicyclopentylcyclopentadiene;
1,1-bis(methoxymethyl)indene; 1,1-bis(methoxymethyl)-2,3-dimethylindene;
1,1-bis(methoxymethyl)-4,5,6,7-tetrahydroindene;
1,1-bis(methoxymethyl)-2,3,6,7-tetrafluoroindene;
1,1-bis(methoxymethyl)-4,7-dimethylindene;
1,1-bis(methoxymethyl)-3,6-dimethylindene;
1,1-bis(methoxymethyl)-4-phenylindene;
1,1-bis(methoxymethyl)-4-phenyl-2-methylindene;
1,1-bis(methoxymethyl)-4-cyclohexylindene;
1,1-bis(methoxymethyl)-7-(3,3,3-trifluoropropyl)indene;
1,1-bis(methoxymethyl)-7-trimethylsilylindene;
1,1-bis(methoxymethyl)-7-trifluoromethylindene;
1,1-bis(methoxymethyl)-4,7-dimethyl-4,5,6,7-tetrahydroindene;
1,1-bis(methoxymethyl)-7-methylindene;
1,1-bis(methoxymethyl)-7-cyclopenthylindene;
1,1-bis(methoxymethyl)-7-isopropylindene;
1,1-bis(methoxymethyl)-7-cyclohexylindene;
1,1-bis(methoxymethyl)-7-tert-butylindene;
1,1-bis(methoxymethyl)-7-tert-butyl-2-methylindene;
1,1-bis(methoxymethyl)-7-phenylindene;
1,1-bis(methoxymethyl)-2-phenylindene;
1,1-bis(methoxymethyl)-1H-benz[e]indene;
1,1-bis(methoxymethyl)-1H-2-methylbenz[e]indene;
9,9-bis(methoxymethyl)fluorene;
9,9-bis(methoxymethyl)-2,3,6,7-tetramethylfluorene;
9,9-bis(methoxymethyl)-2,3,4,5,6,7-hexafluorofluorene;
9,9-bis(methoxymethyl)-2,3-benzofluorene;
9,9-bis(methoxymethyl)-2,3,6,7-dibenzofluorene;
9,9-bis(methoxymethyl)-2,7-diisopropylfluorene;
9,9-bis(methoxymethyl)-1,8-dichlorofluorene;
9,9-bis(methoxymethyl)-2,7-dicyclopentylfluorene;
9,9-bis(methoxymethyl)-1,8-difluorofluorene;
9,9-bis(methoxymethyl)-1,2,3,4-tetrahydrofluorene;
9,9-bis(methoxymethyl)-1,2,3,4,5,6,7,8-octahydrofluorene;
9,9-bis(methoxymethyl)-4-tert-butylfluorene.

The titanium compound used in step (A), (B) and (C) of the present invention is preferably chosen among those of formula Ti(OR)ₙCl₄₋ₙ in which n is comprised between 0 and 3; and R is an alkyl radical having 1-10 carbon atoms or a COR group. Among them, particularly preferred are titanium compounds in which n is from 0 to 2 and particularly TiCl₄, Ti(OBu)Cl₃, Ti(OBu)₂Cl₂. Titanium tetrachloride being the most preferred.

Preferably, in the adduct MgCl₂(ROH)ₙ, where R is a C1-C10 alkyl group, n is from 1 to 5, preferably from 1.5 to 4.5 and more preferably from 2 to 4. R is preferably selected from linear alkyl groups having from 1 to 5 carbon atoms such as methyl, ethyl, propyl, butyl and pentyl, with ethyl being the most preferred. Preferably said adducts are characterized by a particular X-ray diffraction spectrum, in which, in the range of 28 diffraction angles between 5° and 15°, the three main diffraction lines are present at diffraction angles 2θ of 8.8±0.2°, 9.4±0.2° and 9.8±0.2°, the most intense diffraction lines being the one at 2θ=8.8±0.2°, the intensity of the other two diffraction lines being at least 0.2 times the intensity of the most intense diffraction line. These adducts of the present invention can be prepared according to several methods. In particular the general methods described in WO98/44009 are suitable. According to one of these methods, the adduct is prepared by contacting MgCl₂ and alcohol in the absence of the inert liquid dispersant, heating the system at the melting temperature of MgCl₂-alcohol adduct or above, and maintaining said conditions so as to obtain a completely melted adduct. Said molten adduct is then emulsified in a liquid medium which is immiscible with and chemically inert to it and finally quenched by contacting the adduct with an inert cooling liquid thereby obtaining the solidification of the adduct. In particular, the adduct is preferably kept at a temperature equal to or higher than its melting temperature, under stirring conditions, for a time period equal to or greater than 10 hours, preferably from 10 to 150 hours, more preferably from 20 to 100 hours. Alternatively, in order to obtain the solidification of the adduct, a spray-cooling process of the molten adduct can be carried out.

The step (A) of the present invention can be carried out with or without a substantial presence of any electron donor compound. Preferably however, it is carried out in the substantial absence of 1,3-diethers of formula (I).

The step (A) is generally carried out in liquid phase. Usually the titanium compound mentioned above, which is preferably TiCl₄, is used in large excess. As When the titanium compound is, like TiCl₄, liquid at the reaction temperatures ranging from 0° C. to 80° C., it can already constitute the liquid medium of the reaction even if additional liquid diluents may be added. The liquid diluent can be any liquid chosen among those inert with the reactants and preferably belonging to liquid aliphatic or aromatic hydrocarbons optionally halogenated such as hexane, heptane, decane, benzene, toluene, chloroform, dichloromethane etc. Among them aromatic hydrocarbons, optionally halogenated like benzene, tolulene and chlorobenzene are preferred.

Whatever is the liquid medium, it is preferred to keep the concentration of the solid adduct in the step (A) at a level below 120 g/l, preferably below 100 g/l, and most preferably in the range of from 30 to 90 g/l.

The reaction temperature in step (A) ranges from 0 to 80° C., preferably from 10 to 70° C., and more preferably from 20 to 60° C. According to the present invention the reaction temperature is defined as the maximum temperature reached in a given reaction step.

The reaction time of step (A) is not particularly critical it may range from 1 minute to 10 hours but more preferably from 10 minutes to 5 hours and still more preferably from 10 minutes to 3 hours.

The reaction in step (A) is preferably carried out by suspending the adduct in cold TiCl₄ (generally 0° C.); then the so obtained mixture is heated up to about 30-80° C. and kept at this temperature for 0.5-1 hours. After that, the excess of TiCl₄ is removed (either by sedimentation and siphoning or by filtration) and the solid component is subject to the successive step. Optionally, after removal of the titanium compound the solid catalyst component may be recovered and washed before being subject to reaction step (B). The same possibility is available at the end of step (B), before beginning step (C).

The step (B) is carried out by a similar methodology with respect to step (A). The solid coming from (A) which, in a preferred aspect, does not contain any substantial amount of a 1,3-diether of formula (I) is reacted preferably with a titanium compound chosen among those of formula Ti(OR)ₙCl₄₋ₙ as defined above, which is preferably TiCl₄.

As already mentioned this step is carried out in the presence of a 1,3-diether of formula (I) which can be added before, simultaneously or after the addition of the titanium compound. Preferably, it is added to the reaction system after the titanium compound. As a result of this contact, the electron donor compound remains deposited on the catalyst component.

The electron donor compound used in this stage is generally present amounts such as to give Mg/donor molar ratios of from 1 to 15 particularly from 2 to 10.

The reaction temperature is higher than 80° C. and preferably in the range 90-130° C., more preferably from 90 to 120° C. The reaction time ranges from 10 minutes to 5 hours and more preferably from 10 minutes to 3 hours.

In a specific and preferred operative way, step (B) can be performed by first introducing TiCl₄ at 0° C., then when a temperature of 30-50° C. is reached, under stirring, the solid coming from (A) is introduced together with an amount of internal donor so as to give a Mg/donor molar ratio in the range of 2-10. The whole is then heated to 90-110° C. and these conditions were maintained over at least 30 minutes. After that time the stirring is stopped and the liquid phase was separated from the solid either by sedimentation and siphoning or by filtration maintaining the temperature at 100° C.

The solid (optionally isolated and washed) is then subject to step (C) of the process. However, it is possible, and in certain cases advisable, particularly when a larger amount of donor fixed on the catalyst is needed, to repeat step (B) under the same conditions described above.

The step (C) is carried out basically under the same conditions described for the step (B) with the main difference being the fact that the no electron donor is present. The reaction temperature may be higher than that used in step (B) but in any case comprised in the range 90-140° C.

After the step (C) is completed the solid catalyst component is washed with liquid hydrocarbons according to the known techniques.

It has been observed that the process of the invention gives rise to several advantages over the conventional processes in which step (A) is not present. One of them is associated with the reduced settling time of the solid in step (B) which makes possible a reduction of whole production time and therefore a reduction of costs. Another advantage is the higher catalyst recovery with respect to the initial amount of starting adduct. It has been found that the recovery is higher in comparison with the conventional processes where step (A) is not carried out and this also contributes to render an industrial process for the preparation of a catalyst component economically advantageous.

The catalyst components of the invention form catalysts for the polymerization of alpha-olefins CH₂═CHR, wherein R is hydrogen or a hydrocarbon radical having 1-12 carbon atoms, by reaction or contact with organo-Al compounds in particular Al-allyl compounds. The alkyl-Al compound is preferably chosen among the trialkyl aluminum compounds such as for example triethylaluminum, triisobutylaluminum, tri-n-butylaluminum, tri-n-hexylaluminum, tri-n-octylaluminum. It is also possible to use alkylaluminum halides, alkylaluminum hydrides or alkylaluminum sesquichlorides such as AlEt₂Cl and Al₂Et₃Cl₃ optionally in mixture with said trialkylaluminum compounds.

The Al/Ti ratio is higher than 1 and is generally comprised between 20 and 800.

Although the stereospecificity of the catalyst components containing 1,3-diethers as internal donors is already high, an electron donor compound (external donor) which can be the same or different from the compound used as internal donor can be used in the preparation of the catalysts disclosed above in order to still increase the isotacticity of the polymer. The external donor is preferably selected from the silicon compounds containing at least a Si—OR link, having the formula Rₐ¹R_{b}²Si(OR³)_{c}, where a and b are integer from 0 to 2, c is an integer from 1 to 3 and the sum (a+b+c) is 4; R¹, R², and R³, are alkyl, cycloalkyl or aryl radicals with 1-18 carbon atoms.

Particularly preferred are the silicon compounds in which a is 1, b is 1, c is 2, at least one of R¹ and R² is selected from branched alkyl, cycloalkyl or aryl groups with 3-10 carbon atoms and R³ is a C₁-C₁₀ alkyl group, in particular methyl. Examples of such preferred silicon compounds are methylcyclohexyldimethoxysilane, diphenyldimethoxysilane, methyl-t-butyldimethoxysilane, and dicyclopentyldimethoxysilane. Moreover, are also preferred the silicon compounds in which a is 0, c is 3, R² is a branched alkyl or cycloalkyl group and R³ is methyl. Examples of such preferred silicon compounds are cyclohexyltrimethoxysllane, t-butyltrimethoxysilane and thexyltrimethoxysilane.

Also the 1,3-diethers having the previously described formula can be used as external donor.

As previously indicated, the components of the invention and catalysts obtained therefrom find applications in the processes for the (co)polymerization of olefins of formula CH₂HR in which R is hydrogen or a hydrocarbon radical having 1-12 carbon atoms. It has been found that the catalysts formed by the catalyst components prepared according to the process of the invention display a higher activity and better morphological and mechanical resistance during polymerization (evidenced by the higher bulk density and lower percentage of broken polymer particles) with respect to the catalyst component prepared in the absence of step (A).

The catalysts of the invention can be used in any of the olefin polymerization processes known in the art. They can be used for example in slurry polymerization using as diluent an inert hydrocarbon solvent or bulk polymerization using the liquid monomer (for example propylene) as a reaction medium. Moreover, they can also be used in the polymerization process carried out in gas-phase operating in one or more fluidized or mechanically agitated bed reactors.

The polymerization is generally carried out at temperature of from 20 to 120° C., preferably of from 40 to 80° C. When the polymerization is carried out in gas-phase the operating pressure is generally between 0.1 and 10 MPa, preferably between 1 and 5 MPa. In the bulk polymerization the operating pressure is generally between 1 and 6 MPa preferably between 1.5 and 4 MPa.

The catalysts of the invention are very useful for preparing a broad range of polyolefin products. Specific examples of the olefinic polymers which can be prepared are: high density ethylene polymers (HDPE, having a density higher than 0.940 g/cc), comprising ethylene homopolymers and copolymers of ethylene with alpha-olefins having 3-12 carbon atoms; linear low density polyethylenes (LLDPE, having a density lower than 0.940 g/cc) and very low density and ultra low density (VLDPE and ULDPE, having a density lower than 0.920 g/cc, to 0.880 g/cc) consisting of copolymers of ethylene with one or more alpha-olefins having from 3 to 12 carbon atoms, having a mole content of units derived from the ethylene higher than 80%;

They are particularly suited for the preparation of isotactic polypropylenes and crystalline copolymers of propylene and ethylene and/or other alpha-olefins having a content of units derived from propylene higher than 85% by weight; copolymers of propylene and 1-butene having a content of units derived from 1-butene comprised between 1 and 40% by weight; heterophasic copolymers comprising a crystalline polypropylene matrix and an amorphous phase comprising copolymers of propylene with ethylene and or other alpha-olefins.

The following examples are given to illustrate and not to limit the invention itself.

### Characterization

### Determination of X.I.

2.50 g of polymer were dissolved in 250 ml of o-xylene under stirring at 135° C. for 30 minutes, then the solution was cooled to 25° C. and after 30 minutes the insoluble polymer was filtered off. The resulting solution was evaporated in nitrogen flow and the residue was dried and weighed to determine the percentage of soluble polymer and then, by difference, the xylene insoluble fraction (%).

Melt Index: measured at 190° C. according to ASTM D-1238 condition “L”

### EXAMPLES

### Propylene General Polymerization Procedure (A)

In a 4-liter autoclave, purged with nitrogen flow at 70° C. for two hours, 75 ml of anhydrous hexane containing 600 mg of AlEt₃, and 6 mg of solid catalyst component were introduced in propylene flow at 30° C. The autoclave was closed. 1.250 Nl of hydrogen were added and then, under stirring, 1.2 Kg of liquid propylene were fed. The temperature was raised to 70° C. in five minutes and the polymerization was carried out at this temperature for two hours. The non-reacted propylene was removed, the polymer was recovered and dried at 70° C. under vacuum for three hours and then weighed and analyzed for the determination of the Mg residues by which the activity of the catalyst is calculated.

### General Procedure for Preparation of the Spherical Adduct

An initial amount of microspheroidal MgCl₂.2.8C₂H₅OH was prepared according to the method described in ex. 2 of WO98/44009 but operating on a larger scale. The solid adduct so obtained having an average size of 52 μm, was then subject to thermal dealcoholation at increasing temperatures from 30 to 130° C. and operating in nitrogen current until reaching an alcohol content of 2.1 moles per mol of MgCl₂.

### Example 1

Into a 2000 mL four-neck glass reactor, equipped with a mechanical stirrer, a reflux condenser and a thermometer and purged with nitrogen, 1000 mL of TiCl₄ were introduced and cooled to 0° C. While stirring, 50 g of spherical adduct, prepared as described in the previous paragraph, were added. The temperature was raised to 40° C. and maintained at that temperature for 30 minutes. Afterward the stirring was discontinued, the solid product was allowed to settle for 15 minutes, and the supernatant liquid was siphoned off.

### Step (B)

1000 mL of TiCl₄ were added to the solid prepared in step (A). The suspension was heated and, at 40° C., an amount of 9,9-bis(methoxymethyl)fluorene corresponding to 0.200 moles per mole of Mg, were added. The temperature was raised to 100° C. and maintained for 60 min. Then, the stirring was discontinued, the solid product was allowed to settle at 70° C. for 15 minutes and the supernatant liquid was siphoned off.

### Step (C)

Then 1000 mL of fresh TiCl₄ were added on the solid product prepared in step (B). The mixture was reacted at 110° C. for 30 min and than the stirring was stopped and the reactor cooled to 70° C.; the solid product was allowed to settle at 70° C. for 15 min and the supernatant liquid was siphoned off.

Once again, 1000 mL of fresh TiClₐ were added on the solid product. The mixture was reacted at 110° C. for 30 min and than the stirring was stopped and the reactor cooled to 70° C.; the solid product was allowed to settle at 70° C. for 15 min and the supernatant liquid was siphoned off. The solid was washed with hexene three times at 50° C., three more times at room temperature and finally was dried under vacuum at 40° C. The analysis and the result of the polymerization (procedure A) are reported in table 1.

### Example 2

The catalyst component was prepared according to the procedure described in example 1 with the difference that the first reaction between the adduct and TiCl₄ was carried out at 60° C. instead of 40° C. The analysis and the result of the polymerization (procedure A) are reported in table 1.

### Comparison Example 1

The procedure of Example 1 was repeated by omitting the stage (A) of reaction. The analysis and the result of the polymerization (procedure A) are reported in table 1.

TABLE 1

| | Catalyst | | | Polymerization | | | |
|---|---|---|---|---|---|---|---|
| | Composition | | | | | | Broken |
| | Ti | Mg | ED | Mileage | | Bulk | Particles. |
| Ex | (%) | (%) | (%) | (Kg/g) | XI | Density | (%) |
| 1 | 4.0 | 13.7 | 14.1 | 108.4 | 97.4 | 0.41 | 7.7 |
| 2 | 4.0 | 13.7 | 15.1 | 100.9 | 96.6 | 0.40 | 6.2 |
| Comp. 1 | 4.8 | 12.8 | 14.7 | 80.7 | 96.6 | 0.39 | 8.7 |

1-10. (canceled)

11. A catalyst component for polymerizing olefins comprising Mg, Ti, halogen and 1,3-diethers as internal donors, the catalyst component obtained by a process comprising:
reacting an adduct of formula MgCl₂(ROH)ₙ, wherein R is a C₁-C₁₀ alkyl group, and n is from 0.5 to 6, with a titanium compound comprising at least one Ti—Cl bond at a reaction temperature ranging from 0° C. to 80° C. to form a first solid product;
subsequently contacting the first solid product with an electron donor selected from 1,3 diethers with a titanium compound comprising at least one Ti—Cl bond at a temperature higher than 80° C. to form a second solid product; and
subsequently reacting the second solid product with a titanium compound comprising at least one Ti—Cl bond at a temperature higher than 80° C.

12. The catalyst component according to claim 11, wherein the 1,3-diether is selected from 1,3 diethers of formula (I): 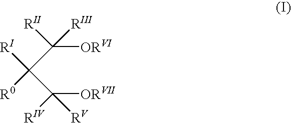
R⁰, R^{I}, R^{II}, R^{III}, R^{IV} and R^{V}, equal or different to each other, are hydrogen or hydrocarbon radicals comprising from 1 to 18 carbon atoms, with the proviso that R^{VI} and R^{VII}, equal or different from each other, are the same as R-R^{V}, except that they cannot be hydrogen, and one or more of R-R^{VII} are optionally linked to form a cycle.

13. The catalyst component according to claim 11, wherein the titanium compound is of formula Ti(OR′)ₙCl₄₋ₙ, wherein n is between 0 and 3; and R′ is an alkyl radical comprising 1-10 carbon atoms, or COR′.

14. The catalyst components according to claim 11, wherein the titanium compound is TiCl₄.

15. The catalyst component according to claim 11, wherein reacting the adduct of formula MgCl₂(ROH)ₙ with the titanium compound at a reaction temperature ranging from 0° C. to 80° C. is carried out in the substantial absence of any 1,3-diether of formula (I).

16. The catalyst component according to claim 11, wherein reacting the adduct of formula MgCl₂(ROH)ₙ with the titanium compound is carried out at a temperature ranging from 10 to 70° C.

17. The catalyst component according to claim 11, wherein when the adduct of formula MgCl₂(ROH)ₙ is reacted with the titanium compound, the concentration of the solid adduct is kept at a level below 120 g/l.

18. A catalyst for polymerizing olefins, the catalyst comprising a catalyst component comprising Mg, Ti, halogen and 1,3-diethers as internal donors, the catalyst component obtained by a process comprising:
reacting an adduct of formula MgCl₂(ROH)ₙ, wherein R is a C₁-C₁₀ alkyl group, and n is from 0.5 to 6, with a titanium compound comprising at least one Ti—Cl bond at a reaction temperature ranging from 0° C. to 80° C. to form a first solid product;
subsequently contacting the first solid product with an electron donor selected from 1,3 diethers with a titanium compound comprising at least one Ti—Cl bond at a temperature higher than 80° C. to form a second solid product; and
subsequently reacting the second solid product with a titanium compound comprising at least one Ti—Cl bond at a temperature higher than 80° C.;
wherein the catalyst component is reacting with at least one organo-Al compound, and optionally with at least one external electron donor compound.

19. The catalyst according to claim 18, wherein the external electron donor compound is selected from silicon compounds comprising at least one Si—OR link, and comprise formula Rₐ¹R_{b}²Si(OR³)_{c}, wherein a and b are integers from 0 to 2; c is an integer from 1 to 3, with the proviso that the sum (a+b+c) is 4; R¹, R², and R³ are alkyl, cycloalkyl or aryl radicals with 1-18 carbon atoms.

20. A process for polymerizing olefins carried out in presence of a catalyst, the catalyst comprising a catalyst component comprising Mg, Ti, halogen and 1,3-diethers as internal donors, the catalyst component obtained by a process comprising:
reacting an adduct of formula MgCl₂(ROH)ₙ, wherein R is a C₁-C₁₀ alkyl group, and n is from 0.5 to 6, with a titanium compound comprising at least one Ti—Cl bond at a reaction temperature ranging from 0° C. to 80° C. to form a first solid product;
subsequently contacting the first solid product with an electron donor selected from 1,3 diethers with a titanium compound comprising at least one Ti—Cl bond at a temperature higher than 80° C. to form a second solid product; and
subsequently reacting the second solid product with a titanium compound comprising at least one Ti—Cl bond at a temperature higher than 80° C.;
wherein the catalyst component is reacting with at least one organo-Al compound, and optionally with at least one external electron donor compound.
